(19) United States
(12) Patent Application Publication
(10) Pub. No.: US 2008/0087140 A1
(43) Pub. Date: Apr. 17, 2008

(54) Driving head for an air wrench

(75) Inventor: Nan-Shin Wang, Wurih Township (TW)

Correspondence Address: BRUCE H. TROXELL, SUITE 1404, 5205 LEESBURG PIKE, FALLS CHURCH, VA, 22041, US

(73) Assignee: MASTER AIR TOOL CORP.

(21) Appl. No.: 11/580,292

(22) Filed: Oct. 13, 2006

(51) Int. Cl. B25B 13/00

(52) U.S. Cl. 81/52

(57) ABSTRACT

A driving head for an air wrench, connected at the front end of a main body of an air wrench and formed with four equal side surfaces, includes a quadrate stage with a preset length and a front end stage having a neck at its rear end connected with the quadrate stage. Each side surface of the front-end stage is formed as an arc starting from the top to the neck to keep its diagonal distance just fit with the quadrate groove of the working sleeve. Therefore, the driving head can drive the working sleeve to work by either fitting the front end stage and the quadrate stage in the quadrate groove completely or fitting only the front end stage in the quadrate groove with an inclined angle.

### BACKGROUND OF THE INVENTION

1. Field of the invention

This invention relates to an air wrench, particularly to one provided with a driving head able to be fitted in a working sleeve vertically or inclinedly.

2. Description of the Prior Art

Commonly, as shown in FIG. 1, a conventional air wrench 1 is provided with a driving head 2 formed quadrate at its front end having a definite length, able to engage vertically with a quadrate groove 4 of a working sleeve 3 to drive the working sleeve 3 to carry out tightening or loosening a screw.

Because such a conventional air wrench 1 can carry out tightening or loosening a screw only when the quadrate groove 4 of the working sleeve 3 is completely engaged with the driving head 2 vertically, it can not work if there is no sufficient space for the driving head 2 to fit in the quadrate groove 4 of the working sleeve 3. Therefore, it should be done manually, causing a low efficient job.

### SUMMARY OF THE INVENTION

The objective of this invention is to offer a driving head for an air wrench able to be fitted in a working sleeve vertically or inclinedly.

The main characteristics of the invention are a driving head provided with a quadrate stage of a preset length for connecting with the front end of a main body of an air wrench, a front portion and a neck jointed between the quadrate stage and the front portion stage. The driving head is formed with four equal side surfaces. Each side surface of the front portion is formed as an arc starting from the top to the neck to keep its diagonal distance just fit with the quadrate groove of the working sleeve. Therefore, the driving head can drive the working sleeve to tighten or loosen a screw by either fitting the front portion stage and the quadrate stage in the quadrate groove completely or fitting only the front portion stage in the quadrate groove with an inclined angle.

### BRIEF DESCRIPTION OF DRAWINGS

This invention is better understood by referring to the accompanying drawings, wherein:

FIG. 1 is a side view of a conventional driving head for an air wrench;

FIG. 2 is a perspective view of a preferred embodiment of a driving head for an air wrench in the present invention;

FIG. 3 is a side cross-sectional view of the preferred embodiment of a driving head for an air wrench in the present invention, showing it being fitted vertically and completely in a working sleeve; and

FIG. 4 is a side cross-sectional view of the preferred embodiment of a driving head for an air wrench in the present invention, showing it being fitted partially in a working sleeve with an inclined angle.

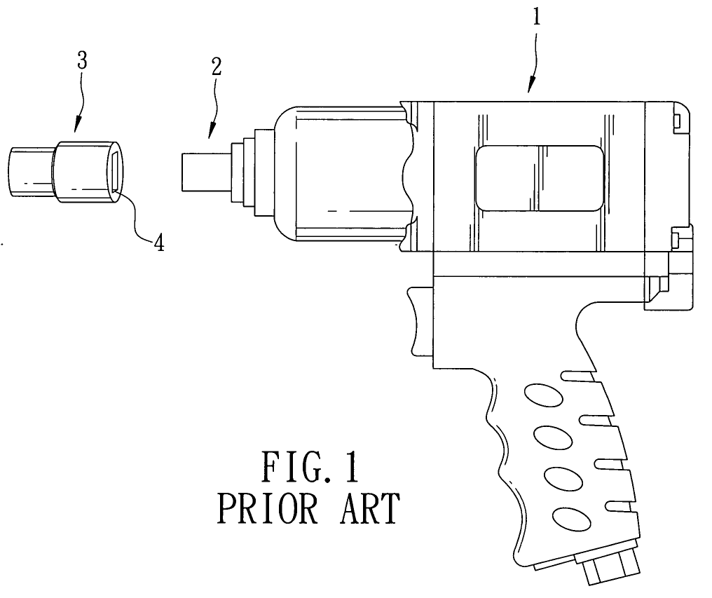

### DETAILED DESCRIPTION OF THE PREFERRED EMBODIMENT

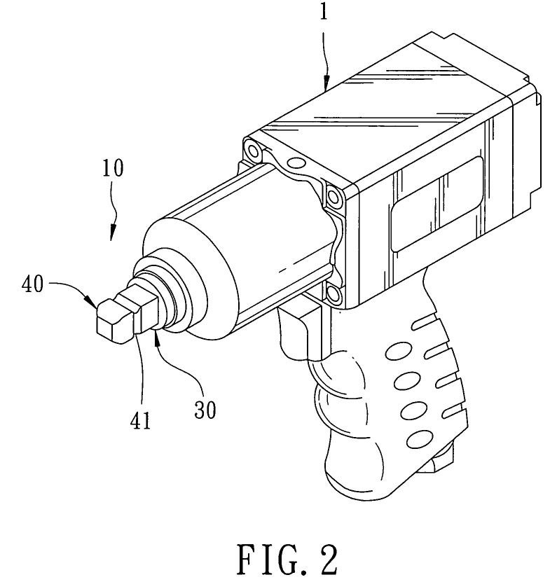

FIGS. 2˜4 show a preferred embodiment of a driving head 10 for an air wrench in the present invention. The air wrench is provided with a main body 1 and the driving head 10 connected at the front end of the main body 1. The driving head 10 able to be fitted in a quadrate groove 21 of a working sleeve 20 is provided with a quadrate stage 30 and a front-end stage 40.

The quadrate stage 30 connected with the front end of the main body 1 is shaped with four surfaces with a preset length for fitting correspondingly in the quadrate groove 21 of the working sleeve 20.

The front-end stage 40 is provided with a neck 41 at its rear end for connecting with the quadrate stage 30. The front end of the front portion stage 40 is formed with four surfaces that are shaped as equal arcs starting from the neck 41 to their tops to keep a distance between the tops points of each diagonal arcs just fit with the quadrate groove 21 of the working sleeve 20. In addition, the surface of the neck 41 is formed nearly concave and located between the quadrate stage 30 and the front-end stage 40. Then the driving head 10 can also drive the working sleeve 20 by fitting the front portion 40 in the quadrate groove 21 in an inclined angle. The inclined angle in the present invention is set between 25 to 30 degrees.

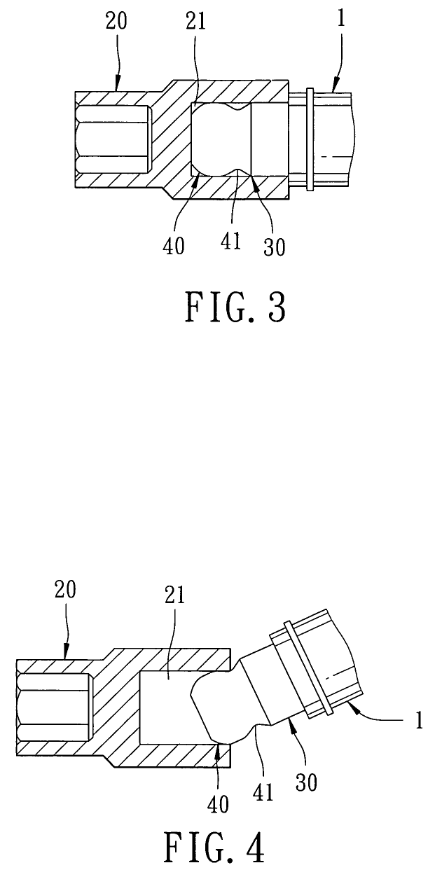

In using, as shown in FIGS. 3 and 4, the driving head 10, including the front-end stage 40, the neck 41 and the quadrate stage 30, is fitted vertically in the quadrate groove 21 of the working sleeve 20 completely when it is used normally. If the driving head 10 can not normally be fitted in the quadrate groove 21 of the working sleeve 20 completely as just described, at first the working sleeve 20 has to be tightened or loosened with a screw, and then, keep the front end stage 40 inclined in a preset angle to fit in the quadrate groove 21 so that one side of the front end stage 40 and that of the neck 41 opposite to the front end stage 40 are just fitted in the quadrate groove 21, enabling the driving head 10 to tighten or loosen a screw.

The invention has the following advantages as can be seen from the foresaid description.

1. With the front-end stage 40 and the neck 41 of the driving head 10 kept in a preset inclined angle and depth relative to the quadrate groove 21, the driving head 10 can be fitted in the quadrate groove 21 of the working sleeve 20 a slope to drive the working sleeve 20 stably.

2. The quadrate rod 30 is designed to have a preset length so that it has sufficient surface area to contact with the wall of the quadrate groove 21, able to prevent the driving head 10 from being vibrated by the air to come off the quadrate groove 21 of the working sleeve 20, impossible to injure people or cause the driving head 10 damaged.

While the preferred embodiment of the invention has been described above, it will be recognized and understood that various modifications may be made therein and the appended claims are intended to cover all such modifications that may fall within the spirit and scope of the invention.

What is claimed is:

1. A driving head for an air wrench, said air wrench provided with a main body connected with said driving head at its front end for fitting in a quadrate groove of a working sleeve to tighten or loosen a screw, said driving head comprising:
a quadrate stage connected with said main body by its rear end and shaped with four surfaces with a preset length for fitting correspondingly in said quadrate groove of said working sleeve;
a front end stage provided with a neck at its rear end for connecting with said quadrate stage, a front end of said front end stage formed with four surfaces that are shaped as equal arcs starting from said neck to the top of said front end stage so as to obtain a distance between the top points of each diagonal arcs just fit with said quadrate groove of said working sleeve, said neck having its surface nearly shaped concave and located between said quadrate stage and said front end stage so that said driving head can also drive said working sleeve by fitting said front end stage only in said quadrate groove in an inclined angle.

2. A driving head for an air wrench as claimed in claim 1, wherein said inclined angle formed between said front end stage and said quadrate groove is set between 25 and 30 degrees.
